(19) United States
(12) Patent Application Publication
(10) Pub. No.: US 2007/0095195 A1
(43) Pub. Date: May 3, 2007

(54) Low power audio processing circuitry for a musical instrument

(76) Inventors: Philippe Pango, Stoney Creek (CA); Brian Keith Gordon, Burlington (CA)

Correspondence Address: Joseph M. Sauer, Esq.;Jones Day, North Point, 901 Lakeside Avenue, Cleveland, OH, 44114, US

(21) Appl. No.: 11/590,016

(22) Filed: Oct. 31, 2006

Related U.S. Application Data
(60) Provisional application No. 60/732,271, filed on Nov. 1, 2005.

(51) Int. Cl. G10H 7/00

(52) U.S. Cl. 84/602

(57) ABSTRACT

In accordance with the teachings described herein, a low power audio processing circuitry is provided. A first converter may be used to convert a received audio signal into a digital input signal. A programmable audio processor may be used to receive audio processing algorithms from an external data port and to store the audio processing algorithms in a memory device. The programmable audio processor may also be used to receive the digital input signal and to process the digital input signal using the audio processing algorithms to generate a digital output signal. A second converter may be used to convert the digital output signal into an audio output signal.

### CROSS-REFERENCE TO RELATED APPLICATIONS

This application claims priority from U.S. Provisional Application No. 60/732,271, titled “Digital Instruments,” filed on Nov. 1, 2005, the entirety of which is incorporated herein by reference.

### BACKGROUND

A guitar player typically needs three elements: a guitar, an amplifier, and a basic effect module. The effect module may achieve one or many well-known effects such as flanger, distortion, compression, reverb, octave, amplifier emulation, etc. An audio signal goes through a series of signal manipulations, or effects, from the guitar microphones (or picks) to the amplifier speaker. These effects typically are performed using three different types of setups. First, the effects may be implemented within the musical instrument itself. Most electric guitars today are capable of performing some basic signal manipulation, such as volume and equalization. Second, the effects may be implemented within the amplifier. Many amplifiers today are capable of doing reverberation, equalization and even compression. Third, the effects may be implemented within an external effect module, such as a basic external effect module comprising a pedal.

Typically, the equipment cost increases with the desire to access a larger number of effects. The drawback of having to buy one extra piece of equipment for every desired effect has lead to the development of effects modules which can implement hundreds, or even thousands of effects. However, even with a multi-effects module, the average musician still has to face two major constraints. First, the built-in effects can rarely be customized, replaced or altered. Indeed, one can rarely modify the parameters associated with the built-in effects that are available. Second, the effects module itself has to be carried, along with the instrument, everywhere the user needs to perform.

Reverberation, delay and chorus are now typically implemented in synthesizers. However, several analog-by-nature instruments are still constrained to older sets of effects, typically volume and equalization (which are implemented by one or more analog potentiometers). This is especially the case for stringed instruments, but may also apply to other instruments, such as reed, brass or percussion instruments.

There is a clear need for an extension of the capabilities of several instruments, such as guitars and microphones in order to ease the portability of the desired effects and enable the user to create, re-customize and adjust the chosen effects, using the instrument controls. This can be achieved by inserting the appropriate digital circuitry within the instrument. The presence of digital circuitry within an instrument permits an entirely new set of features as disclosed herein. The physical size of certain types of instruments may require an integrated solution in order to provide the expected digital signal processing capabilities at a low power consumption and smaller size. Moreover, audio effects can be very complex; therefore, they are best implemented in the digital world, which offers an incredible programming flexibility, enabling the implementation of virtually any imaginable signal processing algorithm.

There have been several attempts to apply complex digital algorithms to the analog output of analog musical instruments. The line of products Line6 include the POD, which is an amplifier emulation module that has a port for digital communication with a PC. It allows the user to select between several amplifier styles, vintage guitars and picks. The POD also includes a USB port to download new algorithms into the effect module. The POD is limited to the family of amplifier emulation algorithms, and thus is unable to implement common audio effects such as distortion and chorus. Moreover, the POD is external to the instrument, and needs to be carried wherever the user needs to play his instrument.

Line6 has also released the Variax guitar, which is a guitar with built-in amplifier and vintage guitar emulation. Again, the Variax guitar implements amplifier emulation only, and the effects parameters cannot be altered by the user.

Gibson's MAGIC digital guitar is a guitar with an Ethernet port to transmit digital audio to other equipment equipped with a corresponding MAGIC chip. It uses the Ethernet network protocol to network audio equipment and reduce the noise that is introduced by cascading several A-to-D and D-to-A components. The MAGIC system adds digital circuitry into the guitar for the purpose of networking it with other equipment (e.g., a mixing console). Also, the MAGIC system imposes hard constraints on the instrument (e.g., device processing time), which makes it unsuitable to implement real-time audio effects.

### SUMMARY

In accordance with the teachings described herein, a low power audio processing circuitry is provided. A first converter may be used to convert a received audio signal into a digital input signal. A programmable audio processor may be used to receive audio processing algorithms from an external data port and to store the audio processing algorithms in a memory device. The programmable audio processor may also be used to receive the digital input signal and to process the digital input signal using the audio processing algorithms to generate a digital output signal. A second converter may be used to convert the digital output signal into an audio output signal.

### BRIEF DESCRIPTION OF THE DRAWINGS

FIG. 1 is a block diagram of an example system for programming audio processing circuitry in a musical instrument.

FIG. 2 is a block diagram of an example low power audio processing circuitry.

FIG. 3 is a block diagram depicting low power audio processing circuitry in a microphone.

FIG. 4 is a block diagram depicting low power audio processing circuitry in a guitar effects pedal.

FIG. 5 depicts example audio processing functions that may be implemented using the guitar pedal of FIG. 4.

FIG. 6 is a block diagram of another example of a low power audio processing circuitry.

### DETAILED DESCRIPTION

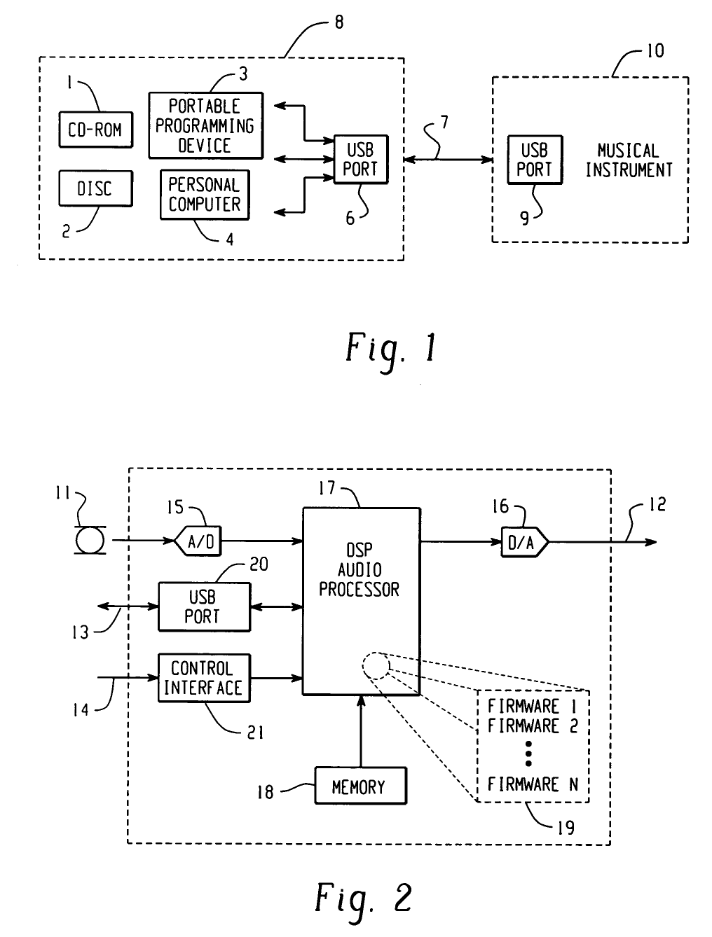

FIG. 1 is a block diagram depicting an example system for programming audio processing circuitry in a musical instrument 10. The system includes a programming and communication device 8 that connects to the musical instrument 10 via a USB link 7. The musical instrument 10 is equipped with programmable audio processing circuitry, as described herein. In operation, the programming and communication device 8 may send and receive data over the USB link 7 to the musical instrument 10. For example, the programming and communication device 8 may be used to load one or more audio processing algorithms (e.g., audio effects) to the audio processing circuitry on the musical instrument 10. In other examples, the programming and communication device 8 may also be used to reprogram audio processing circuitry on the musical instrument 10, receive data from the musical instrument 10 and/or perform other operations by interfacing with the audio processing circuitry on the musical instrument 10.

As illustrated, the programming and communication device 8 includes a data source, such as a CD-ROM 1 or disk 2, which may be used to store software and/or data for programming the musical instrument 10. The programming and communication device 8 also includes a processing device, such as a portable programming device 3 (e.g., laptop, PDA, cell phone, etc.) or a personal computer 4, which is used to execute the programming software and to communicate with the audio processing circuitry on musical instrument 10. In the illustrated example, communication with the musical instrument 10 is facilitated using USB drivers and USB ports 6, 9 on both the programming and communication device 8 and the musical instrument 10. It should be understood, however, that other types of communication links between the programming and communication device 8 and the musical instrument 10 could also be used.

FIG. 2 is a block diagram of an example low power audio processing circuitry, which may be included in a musical instrument or other audio equipment. The circuitry includes an A/D converter 15, a digital signal processor (DSP) 17, a D/A converter 16, a memory 18, a USB interface 20, and a control interface 14. Also illustrated, are an audio source 11 from which the circuitry receives an analog audio signal and firmware 19 that is executed by the DSP 17. The audio source 11 may, for example, be a microphone or any other suitable transduction device to convert a subject analog signal into an electrical signal. The illustrated audio processing circuitry may, for example, be used to expand the signal processing capabilities of an existing analog device by allowing it to emulate several digital algorithms. The circuitry may be implemented on a printed circuit board, as a hybrid integrated circuit or in another circuit format that satisfies the size and power requirements of a specific application.

In operation, the audio source 11 (e.g., microphone) generates an analog audio signal, which is input to the A/D converter 15. The A/D converter 15 digitizes the audio input signal for processing by the DSP 17. The processed audio signal may then be converted back into the analog domain by the D/A converter 16, for example to feed an analog input 12 to an output stage of the device. For instance, if the audio processing circuitry is included in a guitar, then the analog output 12 from the DSP 17 may provide an input to volume and equalization potentiometers in the guitar. In one example, the A/D and the D/A converters 15 and 16 may be implemented using a single CODEC. The DSP 17 is preferably a low power processing device that may be powered by a battery or from power available from an external device via the USB port 13.

The USB port 30 may be used to provide a bidirectional USB link 13 between the audio processor 17 and a programming device in order to facilitate the transfer of programming data, digital audio data and/or other digital data. For instance, the USB port 13 may be used to download personalized signal processing algorithms into the memory device 18. Programming data may, for example, be loaded into memory 18 from a personal computer (PC), a personal digital assistant (PDA), a server, from another musical instrument, or from some other type of processing device. In this manner, the USB port 13 may be provided in a musical instrument to enable the user to download and emulate various real-time digital signal processing algorithms, such as audio effects or amplifier emulation. Using the control interface 14, the user may then program the DSP to control the audio processing functions, such as determining which effect is applied to the audio signal, adjust the parameters of the effects, etc.

The control interface 21 may include control buttons, potentiometers, knobs, switches, push buttons 14 and/or other input devices that may be used to control a DSP processor 17 that is configured to apply desired effects to an audio stream. Using the control interface 21, a user may select or switch between embedded signal processing algorithms, e.g., embedded firmware 19. The firmware 19 may, for example, be configured to perform specific signal manipulations (e.g., different audio effects), and different firmware 10 may be initially stored in an expandable memory 18. The data store 18 may be a Flash memory or other suitable memory device. In one example, the DSP 17 may include its own internal memory to store the firmware 19. In addition, computer code may be stored in either the DSP internal memory 19 or the data store 18, as appropriate, for execution by the DSP 17 for implementing the desired effects or configurations by applying selected signal processing algorithm to the digital audio signal.

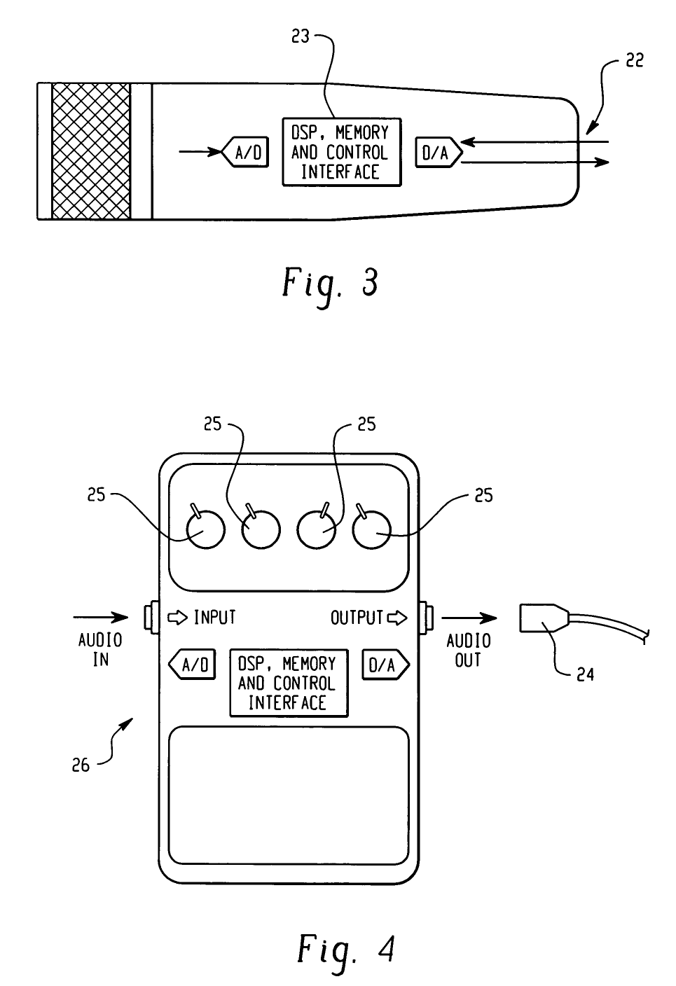

FIG. 3 is a block diagram depicting low power audio processing circuitry 23 in a microphone. In this example, the low power audio processing circuitry of FIG. 2 is included in a hand-held microphone to enable customized voice effects. A USB port 22 facilitates downloading customized voice effects, such as echo, reverberation, equalizer, chorus, into the microphone. A control interface, such as a pushbutton, scroll wheel and screen, etc., may be used to select a desired effect. It should be understood that, in addition to the microphone implementation illustrated in FIG. 3, the low power audio processing circuitry of FIG. 2 may be implemented in any number of instruments or audio devices (e.g., electric or acoustic instruments, effects pedals, etc.)

FIG. 4 is a block diagram depicting low power audio processing circuitry in a guitar effects pedal 26. In this example, the low power audio processing circuitry of FIG. 2 is included in a musical instrument accessory. Typically, a guitar pedal implements only one effect; however, if enabled with the audio processing circuitry of FIG. 2, the pedal can implement multiple effects, which may be downloaded from a server and/or may be customized by the user as described above. A USB port 24 may be used to download the effects into the pedal. Pedal controls 25 may be used to control the effects parameters.

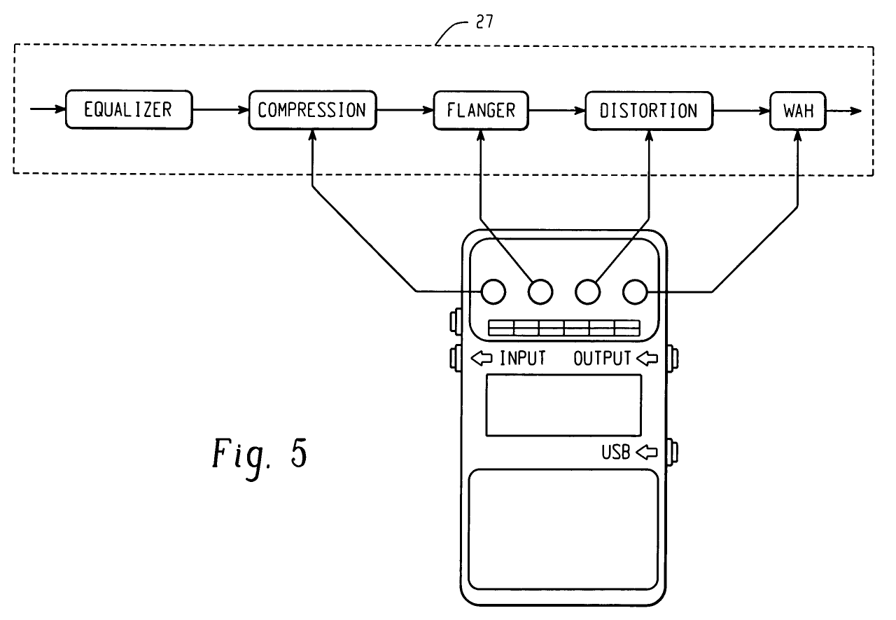

FIG. 5 depicts example audio processing functions 27 that may be implemented using the guitar pedal of FIG. 4. As shown, the pedal may be programmed to implement multiple simultaneous and customized effects, including well-known effects such as flanger, distortion, compression, wah, reverb, octave, amplifier emulation, etc.

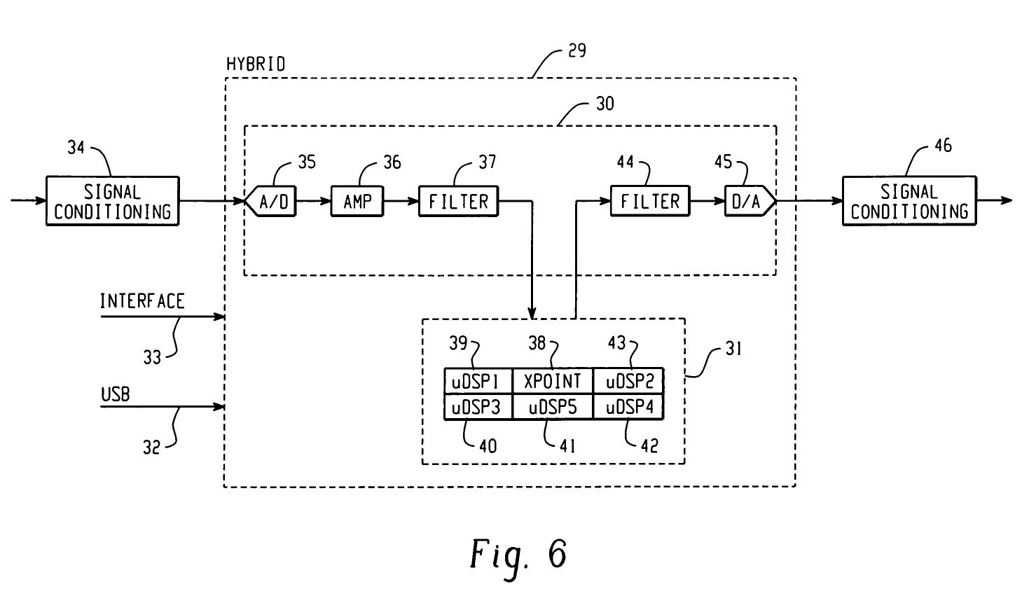

FIG. 6 is a block diagram of another example low power audio processing circuitry, which may be used in a musical instrument or other audio device. The audio processing circuitry includes a signal preparation component 30 and a programmable signal processor 31. Also illustrated are input and output signal conditioning components 34, 46, a USB port 32 and a control interface 33. As illustrated, the digital components of the audio processing circuitry may be implemented as a thin-film hybrid circuit 29. In other examples, however, the circuitry may instead be implemented on a printed circuit board or other circuit device that is suitable to satisfy the size and power requirements of specific applications.

The signal preparation component 30 includes an A/D converter 35, an amplification component 36, one or more input filters 37, one or more output filters 44 and a D/A converter 45. The signal processor 31 is a reconfigurable processing device having a cross point switch 38 that is used to configure a plurality of processing elements 39, 40, 41, 42, 43. An example reconfigurable processor is described in commonly owned U.S. Pat. No. 7,113,589.

The input conditioning element 34 is used to adjust the amplitude of the analog audio input signal to a level that is suitable for the A/D converter 35. For instance, if the analog audio input is from a microphone, then the signal conditioning component 34 may include a microphone pre-amp that steps up the microphone signal. In another example, the signal conditioning component 34 may be used to step down a high amplitude input signal. The audio input is then digitized by the A/D converter 35. Further amplification and signal conditioning functions may be performed by the amplification component 36 and the digital signal may be split into multiple channels by the filter 37. The digital audio signal is then processed by the reconfigurable processor 31 using one or more stored audio processing algorithms (e.g., effects). The processed signal is then filtered 44, for example to combine multiple channels, and is converted back into the analog domain by the D/A converter 45. The output conditioning element 35 may be used to adjust the amplitude of the analog output to a desired level.

The audio processing algorithms applied by the reconfigurable processor 31 may be programmed from an external device via the USB port 32. In addition, the processor 31 may be further configured using the control interface 33. The control interface 33 may, for example, include one or more control buttons, potentiometers, knobs, pedals and/or other input devices that may be used to control the audio processing algorithms utilized by the processor 31.

This written description uses examples to disclose the invention, including the best mode, and also to enable a person skilled in the art to make and use the invention. The patentable scope of the invention may include other examples that occur to those skilled in the art.

The audio processing circuitry described herein may provide several advantages, such as reducing costs associated with the desire to implement several digital signal processing algorithms within an analog device; facilitating the portability of several digital signal processing algorithms; facilitating a user's ability to customize and reconfigure algorithm parameters; facilitating a user's ability to have a direct access to the signal processing parameters using the existing controls mounted on the device, (e.g., switches, push buttons, knobs, and/or small display devices, such as an LCD device); and providing a format and a communication protocol that enables different users to download and share algorithms.

The audio processing circuitry described herein may, for example, be implemented by inserting hardware and software components into an existing instrument device. These hardware and software components may facilitate one or more of the following: downloading the desired digital signal processing algorithms from a computer; customizing the algorithms using a programming device (e.g., a PC); connecting the device to the server using a USB port and a communication protocol designed to facilitate PC and instrument device communication; downloading the desired signal processing algorithm into the memory of the instrument device through a USB port; using a control interface made available on the device to select which signal processing algorithm to apply to the digital signal stream; using a control interface made available on the device to adjust the parameters of the selected signal processing algorithm; and/or other functions.

In one example, the audio processing circuitry described herein may be used to download digital algorithms. The user of a device is provided access to a set of algorithms stored on a data store, such as a CD-ROM, or stored at a website or any similar server. Algorithms may also be shared in a “peer-to-peer” communication between two devices, such as two guitars that include the audio processing circuitry described herein. These algorithms are compiled and organized in a format that can be shared, copied and e-mailed.

In another example, the audio processing circuitry described herein may be used to facilitate customization of the algorithms. The downloaded algorithms can be altered by the user, for example, by using a computer program provided by the device manufacturer. The user is given access to some or all of the parameters of the downloaded algorithms. For example, an audio effect such as Flanger can be later optimized by tuning various parameters such as internal and final mix delay, Stereo phasing, feedback, mode and rate. The parameters of each algorithm can be personalized using pre-recorded test signals. An instrument implementing the systems and methods herein may communicate directly to a personal computer via a USB connection to facilitate a more diverse customization environment.

In one embodiment, the audio processing circuitry described herein may facilitate downloading the effects into the device for a PC. Once the user has downloaded the algorithms from a server and customized the algorithms, the user may download the algorithms to device. This embodiment includes the following software components: software provided by the device manufacturer or a third party that prepares the data or firmware for download; USB drivers and all associated software components needed to enable a communication with a USB device; and a standardized communication protocol specially designed for the PC and device communication through a USB port. This embodiment also may include the following hardware components: a USB system; a USB port on the device that may be implemented with the DSP or on a separate chip that handles I/O tasks; a device memory; and a device DSP.

In one embodiment, the audio processing circuitry described herein may facilitate code storage. The device may include a memory or storage element, e.g. flash memory, which can store a limited amount of firmware. This memory may be expandable in order to increase the storage capacity of the device and increase the number of specific algorithms that can be stored to the device.

In one embodiment, the audio processing circuitry described herein may facilitate a data format. The data transferred to the device may comprise two types of data: a digital code for the DSP and effects data. The digital code may be executable on a processor, and may handle related audio data functions, including interrupt management and audio algorithms. The effects data may comprise parameters to configure the signal processing algorithms.

In one embodiment, the audio processing circuitry described herein may facilitate selection of a desired effect. Once the desired effects have been downloaded into the device, the user can select real time which effects should be run by the device processor. The selection may be made by using the control buttons, switches, push buttons, potentiometers, or knobs available or made available on the device. These controls, which are normally mounted on the device, interrupt the DSP through a control interface, requesting an action to be performed by the DSP. The DSP in the device may be configured to minimize the audible impact on the audio while the system is busy uploading a new effect from the memory. The control interface also may be able to generate signals that can be used to inform the user which algorithm is being applied to the digital stream. These signals can be used to drive various display devices, such as LEDs and alpha-numeric displays. The hardware on the device may receive power from one or more sources. For example, power may be supplied from either a battery or the USB port during programming.

The audio processing circuitry disclosed herein may also be implemented in a variety of devices, such as a guitar with programmable effects, or a microphone with programmable effects, or a universal pedal with programmable effects.

It is claimed:

1. A musical instrument having built in audio processing capabilities, comprising:
a first converter for converting a received audio signal into a digital input signal;
a programmable audio processor configured to receive audio processing algorithms from an external data port and to store the audio processing algorithms in a memory device;
the programmable audio processor being further configured to receive the digital input signal and to process the digital input signal using the audio processing algorithms to generate a digital output signal; and
a second converter for converting the digital output signal into an audio output signal.

2. The musical instrument of claim 1, wherein the musical instrument is a guitar.

3. The musical instrument of claim 1, wherein a battery supplies power to the programmable audio processor.

4. The musical instrument of claim 1, wherein the external data port is adapted for connection to a USB cable.

5. The musical instrument of claim 4, wherein the USB cable supplies power to the programmable audio processor.

6. The musical instrument of claim 1, wherein the programmable audio processor is a reconfigurable processing device.

7. The musical instrument of claim 1, further comprising a control interface to control selection of the audio processing data.

8. The musical instrument of claim 1, wherein the control interface generates a signal so that a display device identifies an audio effect when audio processing data is selected.

9. The musical instrument of claim 1, further comprising a filter that splits the digital input signal into multiple channels for processing by the programmable audio processor.

10. The musical instrument of claim 1, further comprising a signal amplifier to amplify the digital input signal.

11. A signal processing circuit for an audio device, comprising:
a programmable audio processor configured to receive audio processing algorithms from a data port and to store the audio processing algorithms in a memory device;
signal processing circuitry configured to receive an analog input signal and convert the analog input signal into one or more digital audio signals;
the programmable audio processor being further configured to receive one or more digital audio signals from the signal processing circuitry and to process the one or more digital audio signals using the audio processing algorithms to generate a digital output signal;
the signal processing circuitry being further configured to convert the digital output signal into an analog output signal.

12. The signal processing circuit of claim 11, wherein the audio device is a microphone.

13. The signal processing circuit of claim 11, wherein the audio device is an effects pedal.

14. A signal processing circuit for an audio device, comprising:
means for receiving audio processing algorithms from an external device;
means for storing the received audio processing algorithms;
means for receiving an analog input signal;
means for converting the analog input signal into one or more digital audio signals;
a programmable audio processor configured to receive the one or more digital audio signals and to process the one or more digital audio signals using the audio processing algorithms to generate a digital output signal;
means for converting the digital output signal into an analog output signal.
